(19) United States
(12) Patent Application Publication
(10) Pub. No.: US 2017/0006648 A1
(43) Pub. Date: Jan. 5, 2017

(54) ESTABLISHMENT OF SECURE CONNECTIONS BETWEEN RADIO ACCESS NODES OF A WIRELESS NETWORK

(71) Applicant: TELEFONAKTIEBOLAGET LM ERICSSON (PUBL), Stockholm (SE)

(72) Inventors: Joachim ARONIUS, Linköping (SE); Mats GUSTAFSSON, Ljungsbro (SE)

(73) Assignee: TELEFONAKTIEBOLAGET LM ERICSSON (PUBL), Stockholm (SE)

(21) Appl. No.: 15/125,826

(22) PCT Filed: Mar. 13, 2014
(86) PCT No.: PCT/SE2014/050306

§ 371 Date: Sep. 13, 2016

(51) Int. Cl. H04W 76/02; H04L 29/06; H04W 72/04

(52) U.S. Cl. CPC H04W 76/022; H04W 72/0426; H04L 63/164; H04W 88/08

(57) ABSTRACT

The present disclosure relates to methods, radio access nodes and computer-readable storage media for secure connection set up between a first and a second access node of a wireless network.

The method of establishing a secure connection from a first access node (eNB A) to a second access node (eNB B), comprises transmitting a connection termination end point request from the first access node (eNB A) and receiving a response comprising a set of secure connection termination end points for the second access node (eNB B). One or more secure connections are established to the second access node (eNB B), wherein each secure connection includes a secure connection link from the first access node (eNB A) to a termination end point selected from the set of secure connection termination end points.

### TECHNICAL FIELD

The present disclosure relates to methods, radio access nodes and computer-readable storage media for secure connection set up between a first and a second access node of a wireless network.

### BACKGROUND

3GPP Long Term Evolution, LTE, is the fourth-generation mobile communication technologies standard developed within the 3rd Generation Partnership Project, 3GPP, to improve the Universal Mobile Telecommunication System, UMTS, standard to cope with future requirements in terms of improved services such as higher data rates, improved efficiency, and lowered costs. In a typical cellular radio system, wireless terminals also known as mobile stations and/or user equipment units, UEs, communicate via a radio access network, RAN, to one or more core networks. The Universal Terrestrial Radio Access Network, UTRAN, is the radio access network of a UMTS and Evolved UTRAN, E-UTRAN, is the radio access network of an LTE system. In an UTRAN and an E-UTRAN, a User Equipment, UE, is wirelessly connected to a Radio Base Station, RBS, commonly referred to as a NodeB, NB, in UMTS, and as an evolved NodeB, eNB or eNodeB, in LTE. An RBS is a general term for a radio network node capable of transmitting radio signals to a UE and receiving signals transmitted by a UE. In the E-UTRAN, eNBs are interconnected by means of an X2-interface. The S1 interface provides a communication interface from an eNB to a core network.

Mobile service providers need to secure data from interception by unauthorized entities. For LTE, IPSec tunneling between the eNodeB and a security gateway, SecGW, can be used to secure data for providers administering security centrally.

The SecGWs protect the border between security domains of the network, i.e. logically separated domains in the network. The SecGWs are responsible for enforcing the security policy of a security domain towards other SecGWs. The network operator may have more than one SecGWs in its network in order to avoid a single point of failure or for performance reasons. A SecGW may be defined for interaction towards all reachable security domain destinations or it may be defined for only a subset of the reachable destinations.

Within a security domain there is generally a common level of security and a uniform usage of security services. Typically, a network operated by a single network operator or a single transit operator will constitute one security domain although an operator may at will subsection its network into separate sub-networks and implement more than one security domain.

Security gateways are responsible for security sensitive operations and shall be physically secured. In order to protect the S1 and X2 user plane, the 3GPP standard suggests implementation of IPsec. On the core network side a SecGW is used to terminate an S1 IPsec tunnel. IPSec tunneling is also possible to use on the X2 link between two interconnected eNodeBs, whereby a secure link is established by the two nodes.

The S1 IPsec tunnel can be automatically detected by the eNB and X2 IPsec tunnels can be established based on data from automatic neighbor relation, ANR, signaling over S1.

However, present solutions require that there is direct IP connectivity between eNBs in order to make it possible to set up direct IPsec tunnels. In other words, the existing solution requires that there is direct IP connectivity between eNBs in order to make it possible to set up direct IPsec tunnels using the ANR signaling. If there is no direct IP connectivity, establishment of a secure connection will fail. The X2 traffic can then be routed over a default IPsec tunnel used for S1, but as the S1 tunnel normally is terminated close to the core network this will lead to unnecessary X2 delay as the signaling is routed high up in the network.

### SUMMARY

If there is no direct IP connectivity on a transport layer of the wireless network, the X2 IPsec establishment will fail. X2 traffic then passes over a default IPsec tunnel used for S1 which will lead to delays when the signaling is routed higher up in the network hierarchy.

It is an object of the present disclosure to enable improved IP connectivity and set-up of IPsec tunnels between eNBs, when there is no secure IP connection set up between the eNBs. This object is achieved by a method performed in a first access node of a wireless network, of establishing a secure connection to a second access node. The method comprises transmitting a connection termination end point request from the first access node and receiving a response comprising a set of secure connection termination end points for the second access node. One or more secure connections are established to the second access node, wherein each secure connection includes a secure connection link from the first access node to a termination end point selected from the set of secure connection termination end points.

The disclosed method enables establishment of secure connections between eNBs, in particular secure connections between eNBs deployed on different transport networks. The disclosed method reduces the delay for messaging between the eNBs, i.e. the delay for X2 messages, reduces the load on a central security gateway and the load on backhaul.

According to an aspect of establishing a secure connection from a first access node to a second access node, the second access node is a neighboring access node of the first access node.

When receiving a UE reports on a neighboring access node, the disclosed method provides the benefit of simplifying set up of a secure connection to the reported neighboring access node. B

According to an aspect of the disclosure, the set of secure connection termination end points includes at least a first and a second termination end point. The first termination end point is a transport layer address of the second access node. The second termination end point is a security gateway of a first network domain connected to the second access node by means of a secure connection.

Including a first and a second termination point in the set of termination points enables attempts to establish a secure connection according to a preference order, e.g. based on presumed link characteristics.

According to an aspect of the disclosure, the set of secure connection termination end points further comprises one or more secure connection termination end points at one or more security gateways connected to corresponding further network domains.

In accordance with an aspect of the disclosure, the set of secure connection termination end points includes all secure connection termination end points for the second access node.

Receipt of a set of secure connection termination end points including all possible termination end points enables establishment of multiple connections representing all or a subset of possible secure connections.

In accordance with another aspect of the disclosure, the set of secure connection termination end points consists of a single connection termination end point.

According to an aspect of the disclosure, a secure connection is an InternetProtocolSecurity, IPSec, tunnel.

According to an aspect of the disclosure, the request for a secure connection set up is transmitted to a receiving mobility management entity and included in a SON, Self-Organizing Network, information request.

Thus, establishment of a secure connection is at least partially implemented in existing signaling procedures.

According to an aspect of the disclosure path characteristics of each established secure connection is measured in either of the first or the second access node. Based on the measurements, a selection is performed on at least one secure connection to maintain and all other established secure connections are disconnected.

Performance of a measurement or evaluation of link characteristics of for each established link enables selection of an optimal secure connection based on desired characteristics.

According to an aspect of the disclosure, the set of secure connection termination end points is included in the X2 TNL Configuration Info, which X2 TNL Configuration Info is included in the SON Configuration Transfer sent in the ENB CONFIGURATION TRANSFER message.

Thus, establishment of a secure connection is possible using existing message structures in a wireless network.

The disclosure also relates to a radio access node for establishing a secure connection to at least one further radio access node. The radio access node comprises a processor, a communication interface and a memory. The memory contains instructions executable by said processor whereby the radio access node is operative to transmit a connection termination end point request; receive a response comprising a set of secure connection termination end points for the second access node; and establish one or more secure connections to the second access node over the communications interface, wherein each secure connection includes a secure connection link from the first access node to a termination end point selected from the set of secure connection termination end points.

The disclosure also relates to a computer-readable storage medium, having stored thereon a computer program which when run in a first radio access node, causes the radio access node to perform the disclosed method.

The radio access node for establishing a secure connection and the computer-readable storage medium each display advantages corresponding to the advantages already described in relation to the disclosure of the method for establishing a secure connection.

The disclosure further relates to a method performed in a second access node of a wireless network, of providing a secure connection to a first access node. The method comprises receiving a connection termination end point request and transmitting a response comprising a set of secure connection termination end points for the second access node to the first access node. The method also comprises providing a providing a secure connection to each termination end point in the set of secure connection termination end points, thereby enabling establishment of a secure connection from the first access node to the second access node.

According to an aspect of the disclosure, the method performed in the second access node comprises storing a set of secure connection termination end points in the second access node.

According to an aspect of the disclosure, the step of storing the set of secure connection termination end points in the second access node includes compiling the set of secure connection termination end points.

According to an aspect of the disclosure, the set of secure connection termination end points comprises multiple secure connection termination end points.

According to an aspect of the disclosure, the set of secure connection termination end points consists of a single connection termination end point.

The disclosure also relates to a radio access node for providing a secure connection to at least one further radio access node, the radio access node comprising a processor, a communication interface and a memory, said memory containing instructions executable by said processor. The radio access node is operative to receive a connection termination end point request; transmit a response comprising a set of secure connection termination end points to the first access node; and provide a secure connection over the communications interface to each termination end point in the set of secure connection termination end points, thereby enabling establishment of a secure connection from the first access node to the second access node.

The disclosure also relates to a computer-readable storage medium, having stored thereon a computer program which when run in a radio access node, causes the radio access node to perform the method of providing a secure connection.

The method of providing a secure connection, the corresponding radio access node and the computer-readable storage medium each display advantages corresponding to the advantages already described in relation to the disclosure of the method for establishing a secure connection.

### BRIEF DESCRIPTION OF THE DRAWINGS

FIG. 1 schematically discloses a basic LTE architecture;

FIG. 2 schematically discloses X2 and S1 interface connections in a network layout;

FIG. 3
a. is a flowchart schematically illustrating embodiments of method steps for establishing a secure connection, performed in a radio access node;
b. is a flowchart schematically illustrating embodiments of method steps for providing a secure connection, performed in a radio access node;

FIG. 4 is a signaling scheme illustrating signaling during secure connection set-up;

FIG. 5 is a block diagram schematically illustrating a network node for performing the method embodiments.

### DETAILED DESCRIPTION

Aspects of the present disclosure will be described more fully hereinafter with reference to the accompanying drawings. The methods and wireless device disclosed herein can, however, be realized in many different forms and should not be construed as being limited to the aspects set forth herein. Like numbers in the drawings refer to like elements throughout.

The general object or idea of embodiments of the present disclosure is to address at least one or some of the disadvantages with the prior art solutions described above as well as below. The various steps described below in connection with the figures should be primarily understood in a logical sense, while each step may involve the communication of one or more specific messages depending on the implementation and protocols used.

The terminology used herein is for the purpose of describing particular aspects of the disclosure only, and is not intended to limit the disclosure to any particular embodiment. As used herein, the singular forms “a”, “an” and the are intended to include the plural forms as well, unless the context clearly indicates otherwise.

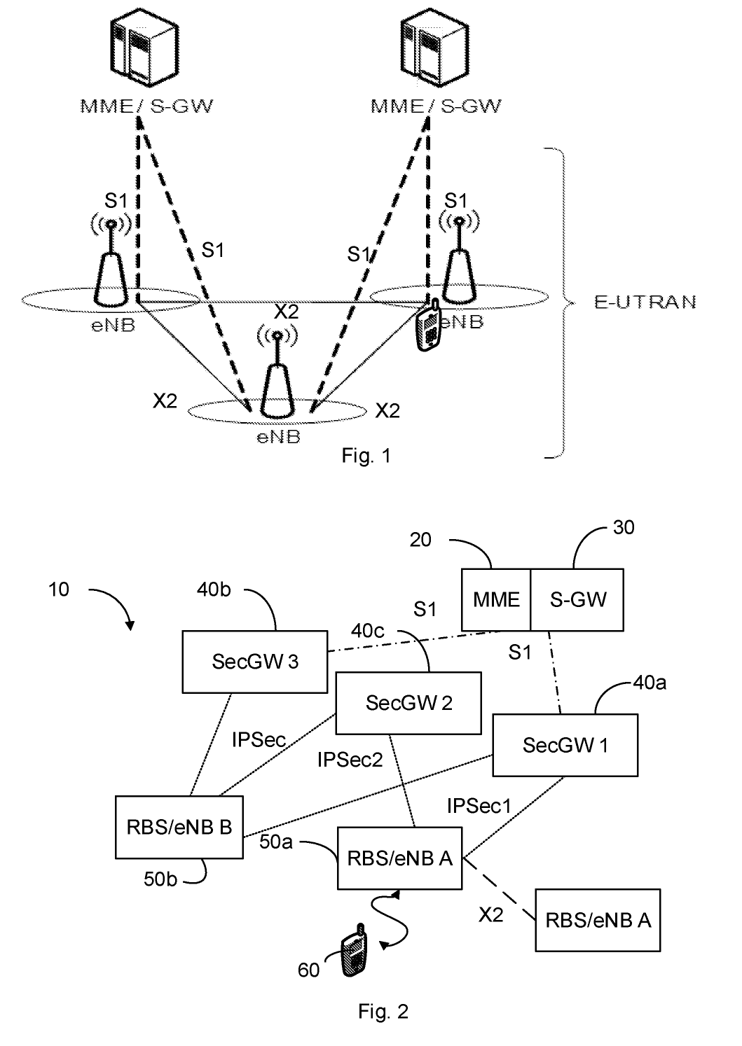

FIG. 1 schematically illustrates a basic LTE architecture, including radio access nodes, also known as radio base stations, RBSs, arranged for communicating with wireless devices over a wireless communication interface. The plurality of RBSs, here shown as eNBs, is connected to MME/S-GW entities via S1 interfaces. The eNBs are connected to each other via X2 interfaces. The following disclosure is based on an implementation in LTE architecture of secure connections, i.e. IPSec, on the S1 and X2 interfaces. However, the disclosed solutions are not limited to implementation in LTE architecture, but are equally applicable in other wireless networks having secure connections established between radio access nodes in the wireless network, i.e. between termination points in one or more transport networks.

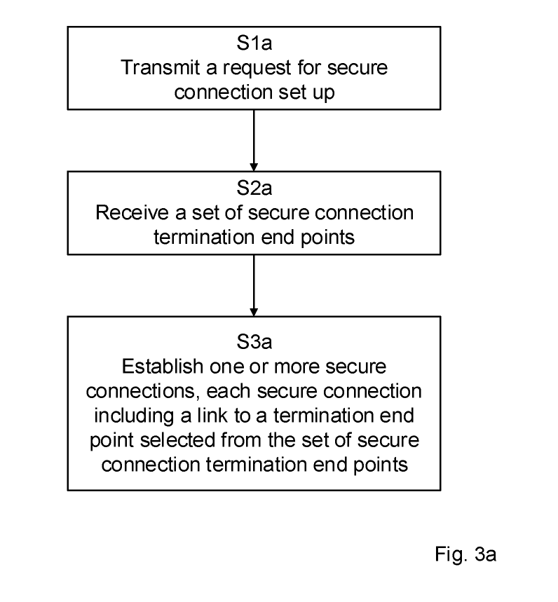

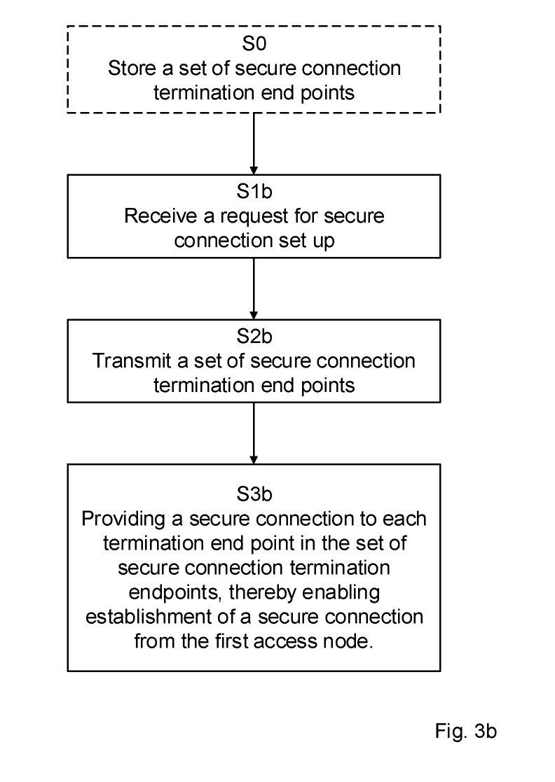

It is an object of the present disclosure to enable improved IP connectivity and set-up of secure connections, IPsec tunnels, between eNBs. FIG. 2 schematically illustrates a more detailed view of transport network connectivity in a layout of a wireless network 10. A wireless device 60 is connected to a first radio access node 50a, here illustrated as an eNB, eNB A. When the wireless device 60 detects a second radio access node 50b, also disclosed as eNB B, here belonging to a second transport network, the wireless device reports the second radio access node eNB B to the first radio access node eNB A to initiate set up of a connection between the first and the second radio access node. In the disclosed wireless network structure, security gateways 40a, 40b and 40c are provided in the X2/S1 interface between eNBs and an MME, Mobility Management Entity 20. A secure connection between eNBs can be set up as a direct secure connection, IPSec tunnel, over the X2 interface, if there is direct connectivity between eNBs. However, in the cases where there is not direct IP connectivity between eNBs, the secure connection is routed over a security gateway 40a-40c. The second access node, eNB B, has secure connection termination end points in SecGW1-3. However, the connecting first access node, eNB A, is only capable of establishing connections to SecGW 1 and 2.

The use of IPsec on S1 and X2 interfaces are a part of the LTE standards. The LTE standard provides for auto detection of the secure connections in the S1 interface, S1 IPsec tunnels, by the eNB during auto integration. Secure connections in the X2 interface, X2 IPsec tunnels are established based on data from ‘Automatic Neighbor Relation’ (ANR) signaling over S1.

As stated above, the existing solution requires that there is direct IP connectivity between eNBs in order to make it possible to set up direct IPsec tunnels using the ANR signaling. If there is no direct IP connectivity, establishment of a secure connection will fail. The X2 traffic can then be routed over a default IPsec tunnel used for S1, but as the S1 tunnel normally is terminated close to the core network this will lead to unnecessary X2 delay as the signaling is routed high up in the network. Therefore, a method in a first access node of a wireless network, of establishing a secure connection to a second access node, is proposed, which is suitable also when there is no IP connection between the two access nodes. An eNB is normally configured to use one security gateway, SecGW, for all S1 traffic.

FIG. 3a is a flowchart schematically illustrating embodiments of method steps performed in a first access node of a wireless network for establishing a secure connection to a second access node. In a first step S1a, the radio access node trying to set up the secure connection, e, g, the first radio access node 50a illustrated in FIG. 2, transmits a request for a connection termination end point addresses. According to an aspect of the disclosure, the request is a Self-Organizing Network, SON Information request with request for X2 TNL configuration info sent to MME from eNB A. The MME forwards the request to a receiving second radio access node eNB B.

According to an aspect of the disclosure, the second access node is a neighboring access node of the first access node eNB A and reported by a wireless device connected to the first access node eNB A.

In a second step S2a, the first radio access node eNB A, receives a response comprising a set of secure connection termination end points for the second access node. A connection termination end point is a point in the network to which the second access node eNB B already has a secure connection. This is implies that if a secure connection is established to a connection termination end point, then there will be a secure connection all the way from the first access node to the second access node. According to aspects of the disclosure, the set of secure connection termination end points includes at least a first and a second termination end point, wherein the first termination end point is a transport network address of the second access node and the second termination end point is an address to a security gateway of a first network domain connected to the second access node by means of a secure connection.

According to an aspect of the disclosure, a secure connection is an InternetProtocolSecurity, IPSec, tunnel.

According to another aspect of the disclosure, the set of secure connection termination end points further comprises one or more secure connection termination end points at one or more security gateways connected to corresponding further network domains.

According to a further aspect, the set of secure connection termination end points includes all or multiple secure connection termination end points that could be used to provide connectivity to the second access node from different IP network domains.

It is of course equally possible for the set of secure connection termination end points to consist of only a single connection termination end point.

Thus, the second radio access node, eNB B, receiving the request for IPsec termination end points, provides a list of different IPSec termination endpoints that the receiving first radio access node eNB A, e.g. a neighboring eNB, can use for secure communication with the second radio access node eNB B. In accordance with the illustration of FIG. 2, possible IPsec termination endpoints are:
The second radio access node's, eNB's, transport network address(es); representing addresses that are sent in messages according to the present 3GPP specification.
The IPsec endpoint address on the S1 security GW, SecGW 3.
One or more IPsec termination endpoints on one or more security GWs, SecGW3 and SecGW1, used for interconnect between different transport networks.

According to an aspect of the disclosure, the eNB B includes the one or more secure connection termination end points in an ‘X2 TNL Configuration Info’ and sends ‘ENB CONFIGURATION TRANSFER’ containing ‘SON Configuration Transfer’ containing ‘X2 TNL Configuration Info’ to a receiving MME. The eNB Configuration Transfer is forwarded to the eNB A from the MME.

The eNB A that receives this information will try to establish connectivity to the eNB B by trying to establish secure connections, IPsec tunnels, to the different secure connection termination endpoints as defined by respective IP addresses included in the set of secure connection termination end points. In step S3a, eNB tries to establish one or more secure connections to the second access node, wherein each secure connection includes a secure connection link from the first access node to a termination end point selected from the set of secure connection termination end points. By connecting to secure connection termination end points representing end points of existing secure connection links a multi-link secure connection is established from the first access node to the second access node providing a multi-link direct secure connectivity between the first and the second access nodes eNB A and eNB B. In a case of direct secure connectivity between the first access node, eNB A, and the second access node, eNB B, there is only on direct link between the two nodes.

Turning now to FIG. 3b, the illustrated flowchart disclose embodiments of method steps performed in a first access node of a wireless network for of providing a secure connection to a first access node. In a first step, the second radio access node eNB B receives a connection termination end point request, e.g. by a SON Information request with request for X2 TNL configuration info forwarded to the receiving second radio access node eNB B from the MME.

The second radio access node, eNB B, transmits a response comprising a set of secure connection termination end points provided for the second access node to the first access node. The eNB B includes the one or more secure connection termination end points in an ‘X2 TNL Configuration Info’ and sends ‘ENB CONFIGURATION TRANSFER’ containing ‘SON Configuration Transfer’ containing ‘X2 TNL Configuration Info’ to a receiving MME. The eNB Configuration Transfer is forwarded to the eNB A from the MME.

In a concluding step S3b, the second radio access node provides a secure connection to each termination end point in the set of secure connection termination end points, thereby enabling establishment of a secure connection from the first access node to the second access node.

According to an aspect of the disclosure, the method of providing a secure connection further includes a step S0 of storing a set of secure connection termination end points in the second access node. In accordance with another aspect of the disclosure, the secure connection termination end points are compiled in the second access node, eNB B.

A node compiles a list of possible secure connection termination endpoints by using one or more of the following methods:
Manual configuration from a management system.
Collection of the secure connection endpoints that the node itself uses to connect to different IP domains.
Collection of secure connection endpoints that has been given to the node from network services such as DHCP and/or DNS.
The use of network topology tools such as trace-route to discover IP interfaces on security GWs that could be used by peer or neighboring nodes.

According to an aspect of the disclosure, the set of secure connection termination end points comprises multiple secure connection termination end points. However, a set of secure connection termination end points consisting of a single connection termination end point is also within the scope of the disclosure, e.g., where the single connection termination end point is a SecGW that the second access node eNB B is connected to.

If connectivity can be established over multiple links either one of the connected eNBs, eNB A or eNB B, is arranged to measure path characteristics, e.g. round trip time (RTT) and choose the optimal path.

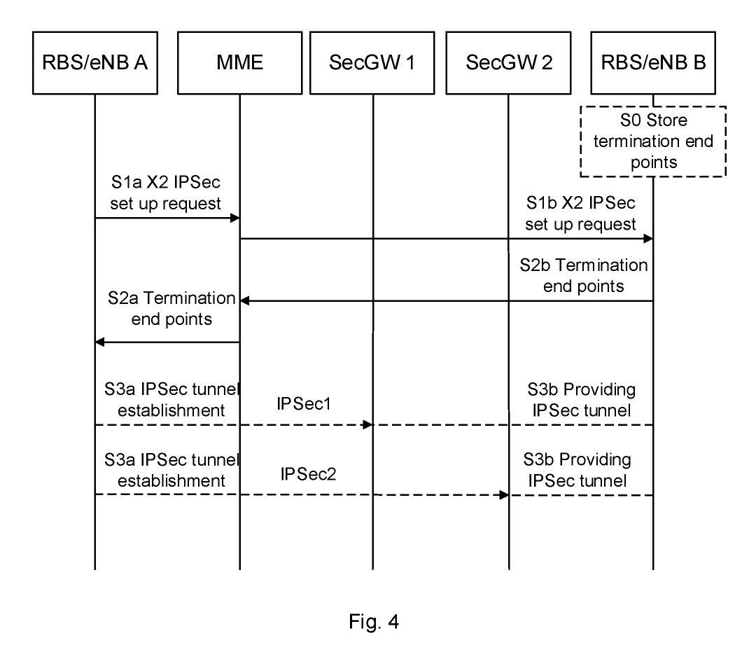

Turning now to FIG. 4, the figure discloses signaling during secure connection set-up. The second radio access node eNB B optionally stores S0 a set of termination end points. The stored secure connection are either manually configured from a management system or collected during operation of the wireless network, as previously described with relation to FIG. 3b. In FIG. 4, the references from FIGS. 3a and 3b are used to illustrate signal exchange during the method steps as disclosed in FIGS. 3a and 3b. The first radio access node, eNB A, having been alerted to a need to set up a secure connection to the second radio access node, eNB B, transmits S1a a connection termination end point request that is addressed to a second access node. An MME, mobility management entity receives the request e.g. a SON Information request with request for X2 TNL configuration info sent to the MME from the eNB A. The receiving MME forwards the connection termination end point request to a receiving, addressed eNB B. The eNB B receives S1b the connection termination end point request, e.g. the SON information request. The eNB B prepares a response to the received request, either based on termination end points already stored in the eNB B or by collecting information on demand on the secure connection endpoints that the eNB B uses or has been provided to the node from network services such as DHCP, Dynamic Host Configuration Protocol and/or DNS, Domain Name System. According to an aspect of the disclosure, the eNB B includes all possible security gateway end point addresses in an X2 Transport Network Layer, TNL, Configuration Info and sends a message ENB CONFIGURATION TRANSFER containing SON Configuration Transfer with the X2 TNL Configuration Info as illustrated in the Tables 1 and 2 below, wherein Table 1 illustrates the information element IE for the X2 TNL Configuration Info and Table 2 defines an maximum number of termination points possible to include within the X2 TNL Configuration Info IE.

Signaling of the set of secure connection termination points in the X2 TNL Configuration Info IE represents an example embodiment for providing the set of secure connection termination points to a requesting access node, wherein the implementation is included in the existing structure for SON, Self-Organizing Network implementation, 3GPP T536.413, clause 9.2.3.26-9.2.3.29. Signaling in other information elements is also possible and within the scope of the disclosure.

TABLE 1
X2 TNL Configuration Info IE

| | | | IE type | | | |
|---|---|---|---|---|---|---|
| | | | and | Semantics | | Assigned |
| IE/Group Name | Presence | Range | reference | description | Criticality | Criticality |
| eNB X2 Transport | | 1 . . . <maxnoofeNBX2TLAs> | | | | |
| Layer Addresses | | | | | | |
| >Transport Layer | M | | 9.2.2.1 | Transport | | |
| Address | | | | Layer | | |
| | | | | Addresses for | | |
| | | | | X2 SCTP end- | | |
| | | | | point. | | |
| eNB X2 Extended | | 0 . . . <maxnoofeNBX2ExtTLAs> | | | YES | ignore |
| Transport Layer | | | | | | |
| Addresses | | | | | | |
| >IP-Sec Transport | O | | 9.2.2.1 | Transport | — | — |
| Layer Address | | | | Layer | | |
| | | | | Addresses for | | |
| | | | | IP-Sec end- | | |
| | | | | point. | | |
| >eNB GTP Transport | | 0 . . . <maxnoofeNBX2GTPTLAs> | | | — | — |
| Layer Addresses | | | | | | |
| >>GTP Transport | M | | 9.2.2.1 | GTP | — | — |
| Layer Address | | | | Transport | | |
| | | | | Layer | | |
| | | | | Addresses for | | |
| | | | | GTP end- | | |
| | | | | points (used | | |
| | | | | for data | | |
| | | | | forwarding | | |
| | | | | over X2). | | |

Table 2 below defines an example range of different type of termination points possible to include within the set of secure connection termination points. The disclosure is not limited by this example range.

TABLE 2

| Range bound | Explanation |
|---|---|
| maxnoofeNBX2TLAs | Maximum no. of eNB X2 Transport Layer |
| | Addresses for an SCTP end- |
| | point. Value is 2. |
| maxnoofeNBX2ExtTLAs | Maximum no. of eNB X2 Extended |
| | Transport Layer Addresses in the |
| | message. Value is 16. |
| maxnoofeNBX2GTPTLAs | Maximum no. of eNB X2 GTP |
| | Transport Layer Addresses for a GTP |
| | end-point in the message. Value is 16. |

A response including the set of secure connection termination end points is sent S2b from the second access node, eNB B, addressed to the requesting first access node, eNB A. The MME receives the message including the set of secure connection termination end points. The MME forwards the message to the requesting first access node, eNB A.

Having the information on a set of secure connection termination end points, i.e. one or more IP addresses to secure connection termination end points, the requesting first access node then establishes S3a one or more secure connections to the second access node by setting up direct connections to the secure connection termination end points, e.g. IPSec1 and IPSec2 of FIGS. 2 and 4. When the first access node eNB A has established a secure connection to one or more secure connection termination end-points, this concludes establishment of a secure connection between the first and second access nodes, since the secure termination end points represent termination end points of already existing secure connections. Thus, the resulting secure connection is a multi-link IPSec tunnel between the first and second access node. Such a multi-link IPSec tunnel is illustrated in FIG. 4, wherein the links IPSec1 and IPSec2 are established to SecGW1 and SecGW2 respectively, each security gateway having a secure connections established to the second access node eNB B.

If connectivity can be established over multiple links the requesting first access node, the responding second access node or a combination of the two termination end points on the secure connection, measure path characteristics, e.g. round trip time RTT. The path characteristics are provided to the requesting first access node, that selects one or more optimal paths for the secure connection based on desired characteristics.

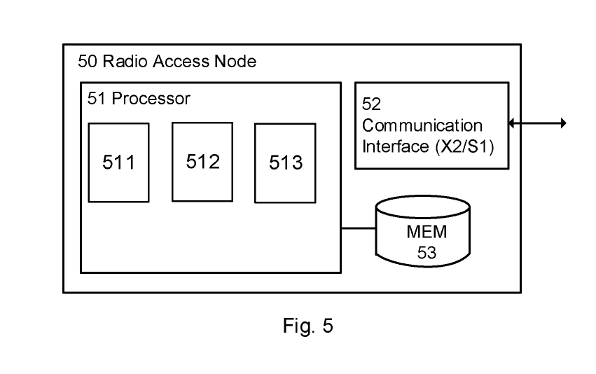

FIG. 5 is a block diagram schematically illustrating some modules for an exemplary embodiment of a radio access node 50 for performing the method step embodiments. The network node 50 comprises a processor 51 or a processing circuitry that may be constituted by any suitable Central Processing Unit, CPU, microcontroller, Digital Signal Processor, DSP, etc. capable of executing computer program code. The computer program may be stored in a memory, MEM 53. The memory 114 can be any combination of a Random Access Memory, RAM, and a Read Only Memory, ROM. The memory 53 may also comprise persistent storage, which, for example, can be any single one or combination of magnetic memory, optical memory, or solid state memory or even remotely mounted memory. The network node 50 further comprises a communication interface 52 configured for X2/S1 interface communication with other nodes in the network, e.g. by means of cellular radio access technology, Wi-Fi, LAN, WLAN.

According to one aspect the disclosure further relates to a computer-readable storage medium, having stored thereon the above mentioned computer program which when run in a radio access node, causes the radio access node to perform the disclosed method embodiments.

When the above mentioned computer program is run in the processor of the radio access node 50, it causes the radio access node to transmit a connection termination end point request over the communications interface. A response is received over the communications interface comprising a set of secure connection termination end points for the second access node. The termination end points in the received set of termination end points are identified in the processor 51, and the termination end points are addressed during establishment of one or more secure connections to the second access node over the communications interface 52, wherein each secure connection includes a secure connection link from the first access node to a termination end point selected from the set of secure connection termination end points.

In another embodiment of the radio access node, the computer program causes the radio access node to receive a connection termination end point request over the communications interface 52. The request is processed in the receiving radio access node and a response including a set of secure connection termination end points is sent to the first access node. The radio access node is further configured to provide a secure connection over communications interface 52 to each termination end point in the set of secure connection termination end points included in the response sent from radio access node.

According to one aspect the disclosure further relates to a computer-readable storage medium, having stored thereon the above mentioned computer program which when run in an identity mediator node, causes the node to perform the disclosed method embodiments.

According to a further aspect of the disclosure processor 51 further comprises one or several of:
a connection termination end point request module 511 configured to request a connection termination end point over the communications interface in the radio access node;
an connection termination end point retrieval module 512 configured retrieve a set of secure connection termination end points from a response received over the communications interface; and
a connection establishment module 513 configured to establish one or more secure connections to the second access node over the communications interface, wherein each secure connection includes a secure connection link from the first access node to a termination end point selected from the set of secure connection termination end points.

The connection termination end point request module 511, the connection termination end point retrieval module 512 and the connection establishment module 513 are implemented in hardware or in software or in a combination thereof. The modules 511, 512, 513 are according to one aspect implemented as a computer program stored in a memory 53 which run on the processor 51.

The above disclosure has been presented for a secure connection between two access nodes of a wireless network. The disclosed embodiments are naturally also applicable for any number of secure connection establishments in a wireless network.

1. A method performed in a first access node of a wireless network, of establishing a secure connection to a second access node, the method comprising:
transmitting a connection termination end point request;
receiving a response comprising a set of secure connection termination end points for the second access node; and
establishing one or more secure connections to the second access node, wherein each secure connection includes a secure connection link from the first access node to a termination end point selected from the set of secure connection termination end points.

2. The method of establishing a secure connection according to claim 1, wherein the second access node is a neighboring access node of the first access node.

3. The method of establishing a secure connection according to claim 1, wherein the set of secure connection termination end points includes at least a first and a second termination end point, wherein the first termination end point is a transport layer address of the second access node and the second termination end point is a security gateway of a first network domain connected to the second access node by a secure connection.

4. The method of establishing a secure connection according to claim 3, wherein the set of secure connection termination end points further comprises one or more secure connection termination end points at one or more security gateways connected to corresponding further network domains.

5. The method of establishing a secure connection according to claim 1, wherein the secure connection termination end points includes all secure connection termination end points for the second access node.

6. The method of establishing a secure connection according to claim 1, wherein the set of secure connection termination end points consists of a single connection termination end point.

7. The method of establishing a secure connection according to claim 1, wherein at least one secure connection is an InternetProtocolSecurity, IPSec, tunnel.

8. The method of establishing a secure connection according to claim 1, wherein the connection termination end point request is transmitted to a receiving mobility management entity and included in a SON, Self-Organizing Network, information request.

9. The method of establishing a secure connection according to claim 1, wherein either of the first or the second access node measures path characteristics of each established secure connection, selects at least one secure connection to maintain based on the measured path characteristics and disconnects all other established secure connections.

10. The method of establishing a secure connection according to claim 1, wherein the set of secure connection termination end points is included in X2 TNL Configuration Info, which X2 TNL Configuration Info is included in a SON, Self-Organizing Network, Configuration Transfer sent in the ENB CONFIGURATION TRANSFER message.

11. A radio access node for establishing a secure connection to at least one further radio access node, the radio access node comprising a processor, a communication interface and a memory, said memory including instructions executable by said processor, whereby the radio access node is operative to:
transmit a connection termination end point request;
receive a response comprising a set of secure connection termination end points for the second access node; and
establish one or more secure connections to the second access node over the communications interface, wherein each secure connection includes a secure connection link from the first access node to a termination end point selected from the set of secure connection termination end points.

12. A computer-readable storage medium, having stored thereon a computer program which when run in a radio access node, causes the radio access node to perform the method as claimed in claim 11.

13. A method performed in a second access node of a wireless network, of providing a secure connection to a first access node, the method comprising:
receiving a connection termination end point request;
transmitting a response comprising a set of secure connection termination end points for the second access node to the first access node; and
providing a secure connection to each termination end point in the set of secure connection termination end points, thereby enabling establishment of a secure connection from the first access node to the second access node.

14. The method of providing a secure connection according to claim 13, further including storing a set of secure connection termination end points in the second access node.

15. The method of providing a secure connection according to claim 14, wherein the step of storing the set of secure connection termination end points in the second access node includes compiling the set of secure connection termination end points.

16. The method of providing a secure connection according to claim 13, wherein the set of secure connection termination end points comprises multiple secure connection termination end points.

17. The method of establishing a secure connection according to claim 14, wherein the set of secure connection termination end points consists of a single connection termination end point.

18. A radio access node for providing a secure connection to at least one further radio access node, the radio access node comprising a processor, a communication interface and a memory, said memory including instructions executable by said processor, whereby the radio access node is operative to:
receive a connection termination end point request;
transmit a response comprising a set of secure connection termination end points to the first access node; and
provide a secure connection over the communications interface to each termination end point in the set of secure connection termination end points, thereby enabling establishment of a secure connection from the first access node to the second access node.

19. A computer-readable storage medium, having stored thereon a computer program which when run in a radio access node, causes the radio access node to perform the method as claimed in claim 18.
